(19) United States
(12) Patent Application Publication
(10) Pub. No.: US 2016/0065669 A1
(43) Pub. Date: Mar. 3, 2016

(54) LOCATION-ORIENTED TEAM INTERCOMMUNICATION

(71) Applicant: AGT International GmbH, Zurich (CH)

(72) Inventors: Eva-Maria VAN DIJKMAN, Frankfurt am Main (DE); Massimiliano Alberto MANZINI, Darmstadt (DE); Anton SNITKO, Griesheim (DE); Maria Paula MARIANI, Frankfurt am Main (DE)

(21) Appl. No.: 14/844,017

(22) Filed: Sep. 3, 2015

Related U.S. Application Data
(60) Provisional application No. 62/045,406, filed on Sep. 3, 2014.

(51) Int. Cl. H04L 29/08; H04W 4/02; H04N 21/4788; H04N 7/14; H04N 21/431; H04L 12/58; H04W 4/14

(52) U.S. Cl. CPC H04L 67/1091; H04L 67/18; H04L 51/10; H04W 4/02; H04W 4/14; H04N 7/144; H04N 7/147; H04N 21/4312; H04N 21/4788; H04N 2007/145

(57) ABSTRACT

A system and method for intercommunication among the members of a team employing user devices, organized around maps of the locations of the team members presented on the display screens of the user devices. Team members manage intercommunications among themselves by selections made according to the displayed maps and icons thereon. The maps provide a flexible framework around which to structure various modalities of intercommunication including chat, voice, audio-video camera streaming, or a data stream from a sensor, which are graphically indicated on the maps. Organizing and managing according to icons of team members on the maps provides flexible intercommunication without excessive constraint, facilitating intuitive and easy operation. When posting of geographical location of a team member is not desired, a ghost mode permits a team member to freely interact with the group without divulging location.

### CROSS REFERENCE TO RELATED APPLICATIONS

This application claims the benefit of U.S. provisional Application No. 62/045,406 filed on Sep. 3, 2014 which is hereby incorporated by reference in their entirety.

### BACKGROUND

Team members often need to intercommunicate in free-form fashion in response to changing circumstances. They may need to communicate on a one-to-one basis, a one-to-many basis, a many-to-one basis, and on a one-to-all basis, as necessary. Communication may be verbal and/or visual, and may involve information accompanying the communication. In addition, automatically-collected information about team members may be needed as part of team intercommunication.

Although team intercommunication needs to be as free as possible from external restrictions, communication systems must necessarily impose certain structural constraints for successful functioning. There is thus a challenge in developing a suitable team intercommunications system: to establish a structural framework in which the intercommunication system can work reliably and dependably, not only to handle the required throughput and bandwidth of the communications, but also to provide a natural and unencumbered user interface; while at the same time allowing as much freedom as possible to the team members, regarding the manner in which they use the system. These goals are met by embodiments of the present invention.

### SUMMARY

Embodiments of the present invention provide a system and methods for team intercommunication using communication devices including, but not limited to: smartphones, tablet computers, personal computers suitable for desktop use, and augmented reality glasses (such as Google “Glass”). Communication technologies utilized include, but are not limited to: cellular data; WiFi; Bluetooth.

The term “team” herein denotes a multiplicity of associated individuals, who are herein denoted as “team members”. According to various embodiments of the present invention, each team member has a user device for communicating with the other members of the team via their respective user devices. In a related embodiment, each user device is a smartphone, a tablet computer, a personal computer; or augmented reality glasses (such as Google “Glass”); and each user device has an active connection to the Internet or other network for communicating with the other user devices of the respective team members. In another related embodiment, at least one team member has a mobile user device.

According to various embodiments of the invention, a team intercommunication system is location-oriented around an interactive map including one or more geographical areas where team members are located. According to certain embodiments of the invention, display and visibility of team members and other objects of interest (such as hotspots) is coordinated and managed via the map.

In an embodiment of the invention, a geographical area is equipped with sensors providing real-time information about the area. Non-limiting examples of such sensors include video cameras and license plate readers (LPR's). According to a related embodiment, a team has an assigned purpose or function that has some relation to a geographical area where team members and/or sensors are located. In a non-limiting example, a team may be assigned to monitor and enforce security in an airport. In another non-limiting example, a team may be assigned to survey and report on the operation of an urban transportation system. In still another non-limiting example, a team may be assigned to handle a real-time emergency situation, such as an industrial accident involving a chemical spill that must be contained. Examples of this sort illustrate and suggest the breadth and variety of team intercommunication needs, and the requirement that the system be as free from user constraint as possible. In this spirit, certain embodiments provide voice talk as well as text chat capabilities, to simulate a walkie-talkie experience where advantageous.

Various embodiments of the present invention provide for easy and facile switching of the user among various views, including a team view and a “Me” view, and from chatting to video presentation. An embodiment of the invention also provides a “ghost mode” that allows a team member to be an active part of the team, while not appearing on anyone else's map. In a related embodiment, ghost mode can be automatically scheduled for enablement and disablement according to time and/or location or other factors.

A “Me” view embodiment provides for automatically selecting nearby team members for a highlighted presence, and provides a means for a team member to automatically send information and content to himself or herself.

Other embodiments of the invention provide hotspots, which team members can select for communicating with other team members currently located at the hotspots. Map pins are also provided by embodiments of the invention, and can be sent and received among team members, such as for conveniently arranging ad hoc meetings.

Various embodiments of the present invention also provide video camera stream capabilities, to enrich the visual information available to team members in real time. A team member may send and receive video camera streams, which are depicted on the map, color-coded to identify source and destination. In a related embodiment, a team member may request a video camera stream from another team member in a particular location. Certain embodiments of the present invention provide audio streams along with video streams.

It is an object of the present invention to provide a system for sharing information among a plurality of members of a team, the system comprising a plurality of user devices, wherein a each of the user devices has:
a display screen,
at least one memory unit,
at least one processing unit,
an input unit, and
a connection to the Internet or other network;
   wherein each member of the team has a user device; and
   wherein a each of the user devices is configured to:
present a map on the display screen thereof, the map containing:
   the location of the user device, and
   the location of at least one user device of at least one other team member;
accept an input from a member of the team, the input containing at least one of the following elements group consisting of:
   the team as a whole,
   the member of the team,
   another member of the team,
   a predefined geographical hotspot,
   a map pin,
   a video camera stream,
   a data stream from a sensor, and
   a chat pane; and
responsively to the input, to enable a communication between at least two members of the team and involving the selected element.

It is another object of the present invention to provide the system as mentioned above, wherein the user device is further configured to send a video camera stream to another user device, and to graphically indicate the sending on the map.

It is another object of the present invention to provide the system as mentioned above, wherein the user device is further configured to receive a video camera stream from another user device and to graphically indicate the receiving on the map; and wherein the user device further configured for at least one of:
store the video camera stream, and
display the video camera stream.

It is another object of the present invention to provide the system as mentioned above, wherein the user device is further configured to allow a team member to suppress display of the team member's map location on user devices of other team members.

It is another object of the present invention to provide the system as mentioned above, wherein the user device is further configured to allow a team member to request a video camera stream or a data stream from a sensor from another team member.

It is another object of the present invention to provide the system as mentioned above, wherein the user device is further configured to display an icon of a team member on the map according to the team member's map location.

It is another object of the present invention to provide the system as mentioned above, wherein the icon of the team member on the map comprises a visual indicator of a field-of-view of a camera of a user device of the team member.

It is an object of the present invention to provide a computer implemented method for sharing information among a plurality of members of a team, each member of the team being provided with at least one user device comprising:
a display screen,
at least one processor,
at least one memory unit,
an input unit, and
a connection to the Internet or other network;
   the method comprising:
presenting a map on the display screen of at least one user device, the map containing:
the location of the user device, and
the location of at least one user device of at least one other team member;
accepting an input from a member of the team, the input containing at least one of the group consisting of:
the team as a whole,
the member of the team,
another member of the team,
a predefined geographical hotspot,
a map pin,
a video camera stream,
a data stream from a sensor, and
a chat pane; and
enabling a communication between at least two members of the team, responsively to the accepted input and with accordance to the input's content.

It is an object of the present invention to provide a transitory or non-transitory computer readable medium (CRM) that, when loaded into a memory of a computing device and executed by at least one processor of the computing device, configured to execute the steps of a method for sharing information among a plurality of members of a team each being provided with at least one user device, as mentioned above.

It is another object of the present invention to provide the method as mentioned above, further comprising:

sending a video camera stream from one user device to another user device; and

graphically indicating the sending act on the map.

It is another object of the present invention to provide the method as mentioned above, further comprising:

receiving a video camera stream from one user device; and

graphically indicating the receiving act on the map.

It is another object of the present invention to provide the method as mentioned above, further comprising at least one of:

storing the video camera stream; and

displaying the video camera stream.

It is another object of the present invention to provide the method as mentioned above, further comprising allowing a team member to suppress display of the team member's map location on user devices of other team members.

It is another object of the present invention to provide the method as mentioned above, further comprising allowing a team member to request a video camera stream and/or a data stream from a sensor from another team member.

It is another object of the present invention to provide the method as mentioned above, further comprising displaying an icon of a team member on the map according to the team member's map location.

It is another object of the present invention to provide the method as mentioned above, further comprising presenting a visual indicator of a field-of-view of a camera of a user device of a team member.

### BRIEF DESCRIPTION OF THE DRAWINGS

The subject matter disclosed may best be understood by reference to the following detailed description when read with the accompanying drawings in which:

FIG. 1 illustrates a screen team view with chat closed and video shutter closed, according to an embodiment of the invention.

FIG. 2 illustrates a screen team view with chat opened and video shutter partially opened, according to an embodiment of the invention.

FIG. 3 illustrates a screen team view with chat closed and video shutter partially but wider opened, according to an embodiment of the invention.

FIG. 4 illustrates a screen team view with chat opened and video shutter closed, according to an embodiment of the invention.

FIG. 5 illustrates a screen with video shutter fully opened, according to an embodiment of the invention.

FIG. 6 illustrates a screen chat with another team member, according to an embodiment of the invention.

FIG. 7 illustrates a screen chat with another team member who is in a “ghost mode”, according to an embodiment of the invention.

FIG. 8 illustrates a screen hotspot view and chat with another team member in the hotspot area, according to an embodiment of the invention.

FIG. 9 illustrates a screen map pin detail view, according to an embodiment of the invention.

FIG. 10 illustrates a screen showing a map pin sent to another team member, according to an embodiment of the invention.

FIG. 11 illustrates a screen showing a map pin received from another team member, according to an embodiment of the invention.

FIG. 12 illustrates a screen showing a video camera stream being sent to another team member, according to an embodiment of the invention.

FIG. 13 illustrates a screen showing video camera stream being received from another team member, according to an embodiment of the invention.

FIG. 14 illustrates a screen showing a menu for requesting a video camera stream from another team member, according to an embodiment of the invention.

FIG. 15 illustrates a screen “Me” view for a user device of a team member, according to an embodiment of the invention.

FIG. 16 illustrates a screen “Me” view for the user device of the team member and chat with other team members proximate to the team member's location, according to an embodiment of the invention.

FIG. 17 illustrates a screen “Me” view for the user device of the team member when in “ghost mode”, and chat with other team members proximate to the team member's location, according to an embodiment of the invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

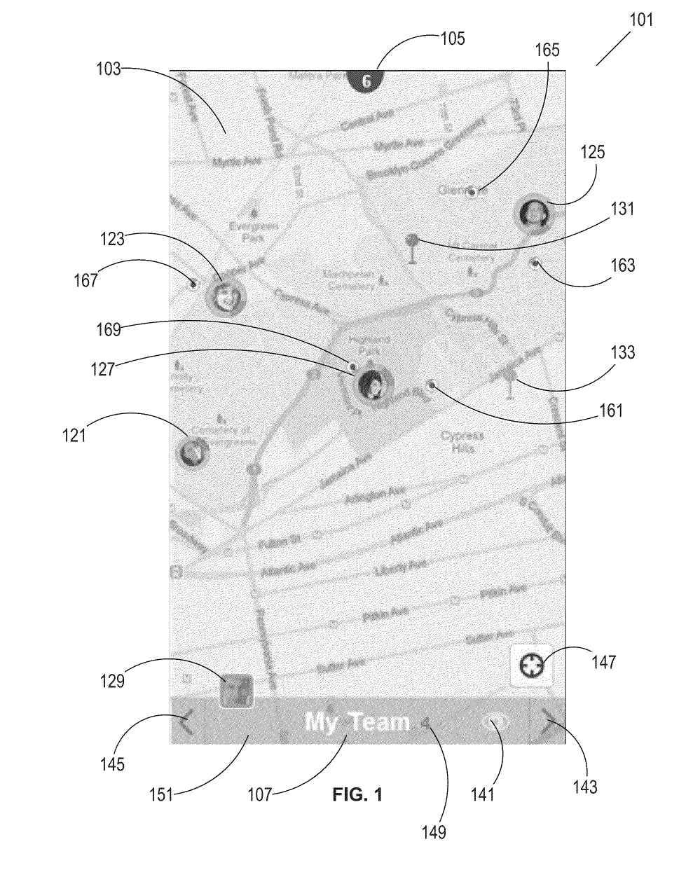

FIG. 1 illustrates a screen team view 101 with a map 103 showing an icon 121 representing the location of the team member upon whose user device screen team view 101 is shown, according to an embodiment of the invention. In a related embodiment, the team member who owns the device is referred to as “Me” on the screen pages (detailed in following sections), and icon 121 is accordingly referred to as the “Me” icon. Chat (not shown) is closed and a video shutter handle 105 is closed. A banner 107 indicates that the view is a team view. A number displayed in video shutter handle 105 typically indicates a count of video cameras in the area. An icon 123 for a team member “Elizabeth”, an icon 125 for a team member “Massimiliano”, and an icon 127 for a team member “Paula” are shown on map 103 according to the current locations of those team members. An icon 129 for a team member “Anton” is shown for a team member who is not visible on map 103 (in a “ghost mode”, as detailed herein in a following section). The user can tap or click on an icon to go immediately to the view of the respective team member. Alternately, the user can scroll forward and backward to pages for all the team members and hotspots (detailed in a following section) by tapping or clicking on arrows 143 and 145, respectively. A map pin 131 and a map pin 133 are also shown, and are detailed herein in a following section. A button 141 can be used to open or close chat mode, where applicable; and to open or close a video camera streaming window, where applicable. Tapping on a banner bar 151 also opens and closes the chat pane, where applicable. In a related embodiment, zooming or panning map 103 also closes the chat pane. A button 147 can be used to return to team view directly from any other view. A counter 149 displays the number of other team members in the area. Icons 161, 163, 165, 167, and 169 represent video cameras installed in the indicated areas on map 103. In addition to identifying camera position, a camera icon indicates the direction the camera is currently pointing.

According to various embodiments of the present invention, icons and other objects appearing on the screens are color-coded to associate them with other team members, as distinct from the user of the device on which the screen appears. In a non-limiting example, map pin 131 is color-coded to match the outer ring of “Me” icon 121, visually indicating that map pin 131 was generated by the user of the device on which the screen appears (i.e., the user is “Me”). Conversely, 133 is color-coded to match the outer ring of other team member icon (such as icon 125), visually-indicating that map pin 133 was generated by another team member. The color-coding scheme is used consistently throughout, to identify chat balloons according to sender, as well as page identifier banner bars.

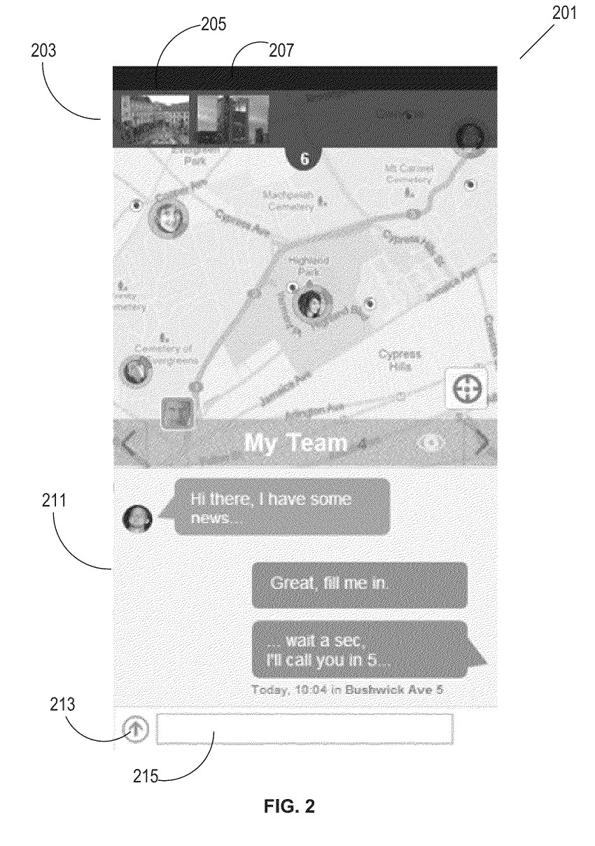

FIG. 2 illustrates a screen team view with a chat pane 211 opened and a video shutter 203 partially opened, according to an embodiment of the invention. By touching and dragging video shutter 203 down (like a window shade), video shutter 203 can be opened to varying degrees. In addition, the user can scroll chat messages up and down in chat pane 211, and can enter chat text in a text entry box 215. Video shutter 203 contains a frame (or “tile”) 205 and a frame 207, corresponding to video images received from cameras in the area. A button 213 opens a menu of choices, as detailed in a following section.

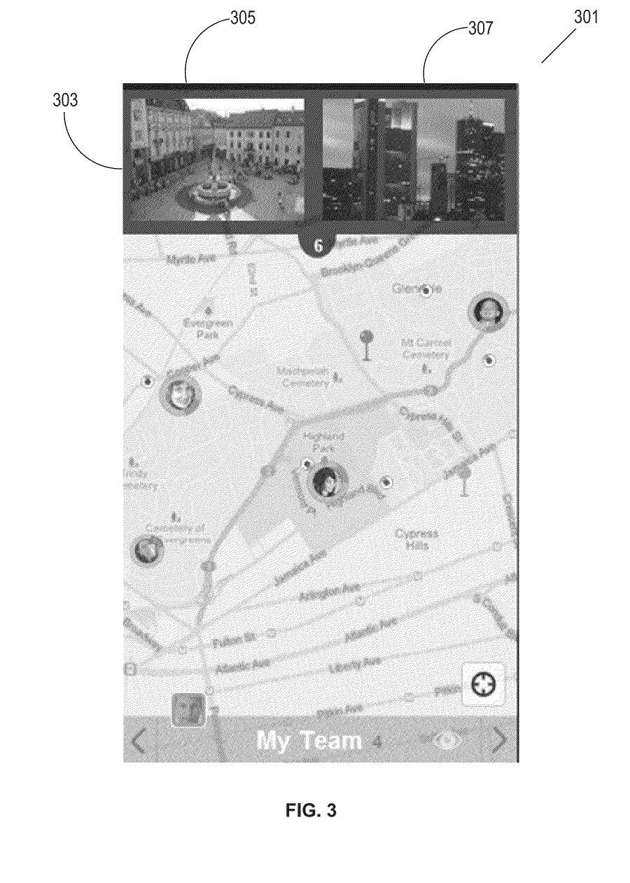

FIG. 3 illustrates a screen team view 301 with chat pane (not shown) closed and video shutter 303 partially opened, but opened wider than video shutter 203, according to an embodiment of the invention. A frame 305 and a frame 307 are shown, corresponding to frames 205 and 207, respectively (from FIG. 2), but are dynamically resized because of the wider opening of video shutter 303.

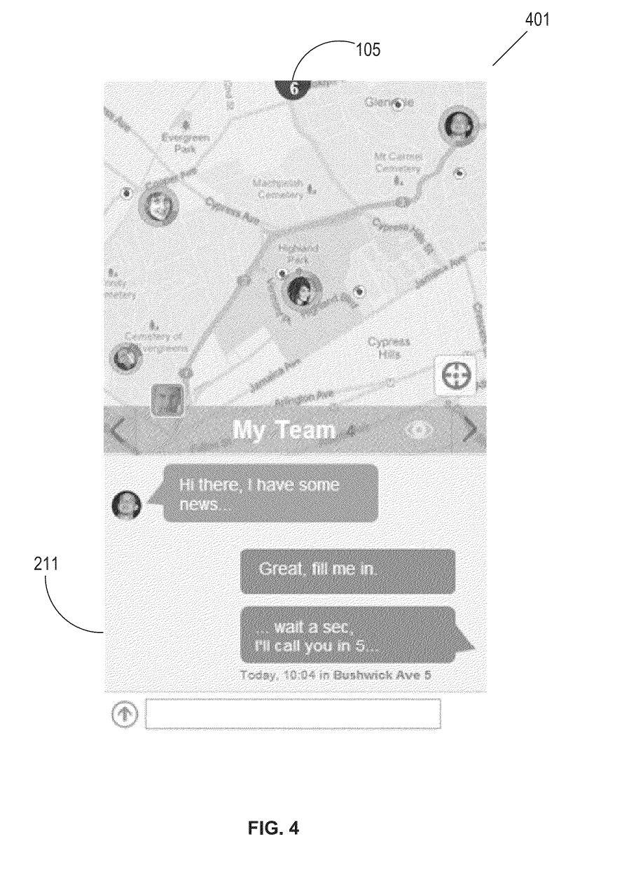

FIG. 4 illustrates a screen team view 401 with chat pane 211 opened and video shutter handle 105 closed, according to an embodiment of the invention.

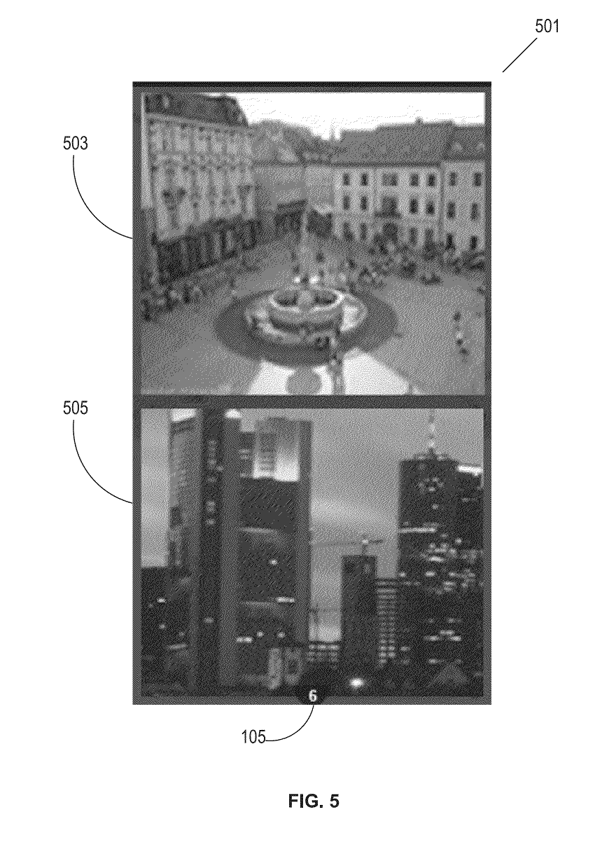

FIG. 5 illustrates a screen with the video shutter fully opened by dragging video shutter handle 105 to the bottom of the screen, according to an embodiment of the invention. A frame 503 and a frame 505 corresponding to frames 205 and 207, respectively (from FIG. 2), are thereby dynamically expanded to full allowable size.

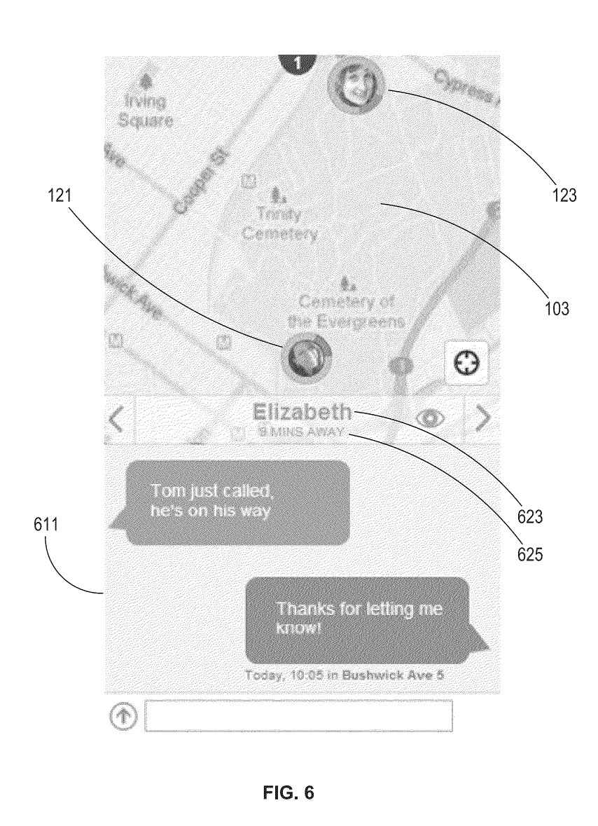

FIG. 6 illustrates a screen chat pane 611 for chat between the team member (represented on map 103 by “Me” icon 121) whose user device is displaying the screen, and another team member (“Elizabeth”, represented on map 103 by icon 123), according to an embodiment of the invention. A banner 623 shows that this is the page of team member “Elizabeth”, and that she is about 9 minutes away by transit according to a notification 625.

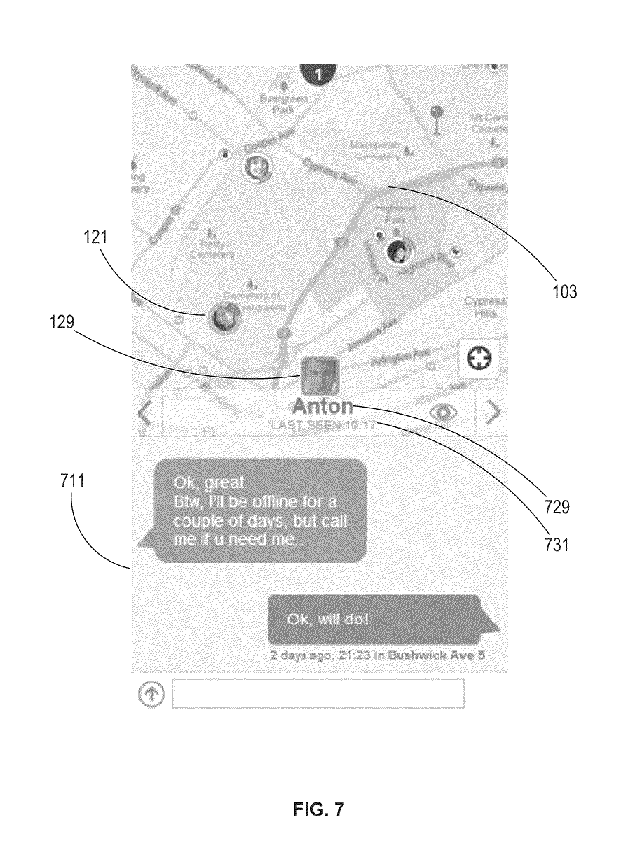

FIG. 7 illustrates a screen chat pane 711 for chat between the team member (represented on map 103 by “Me” icon 121) whose user device is displaying the screen and another team member (“Anton”, represented by icon 129) who is in a “ghost mode”, according to an embodiment of the invention. A team member in “ghost mode” is available for communication, but the team member's location is unspecified, and no icon for the team member appears on map 103. Instead, icon 129 appears off map 103. A banner 729 shows that this is the page of team member “Anton”, and that he was last located on map 103 at 10:17 according to a notification 731.

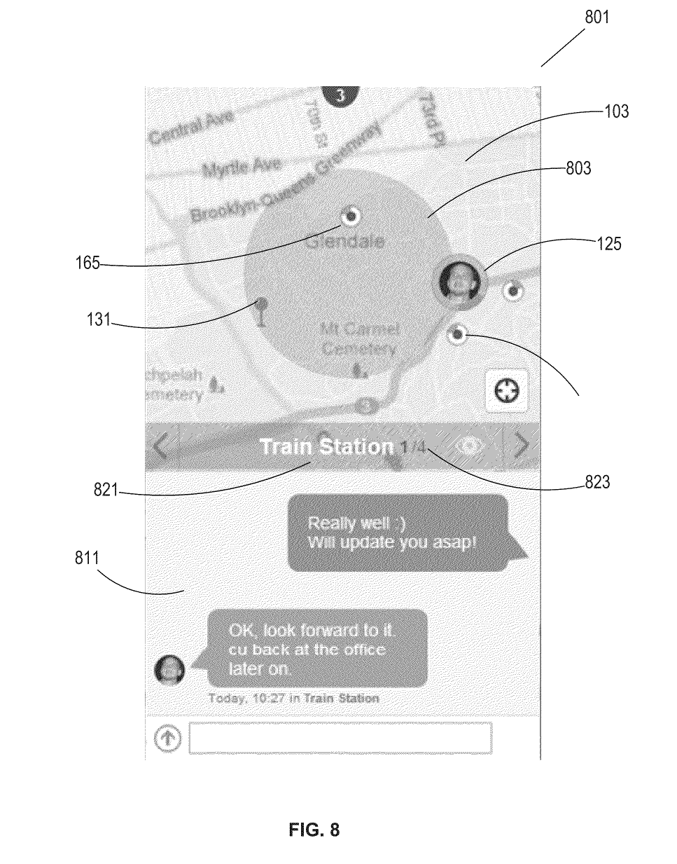

FIG. 8 illustrates a screen hotspot view 801 and chat pane 811 with team member “Massimiliano” represented by icon 125 on map 103 in a hotspot area 803, according to an embodiment of the invention. A banner 821 identifies hotspot area 803 as “Train Station”, and a notification 823 informs that 1 team member out of 4 is in hotspot area 803. It is also seen that map pin 131 and camera icon 165 are within hotspot area 803, and camera icon 163 is near the periphery thereof.

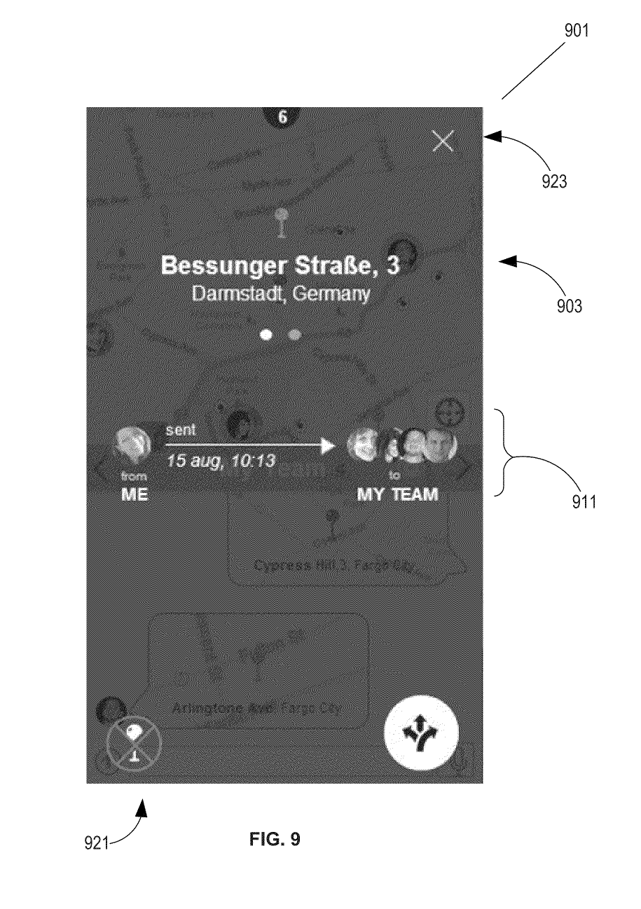

FIG. 9 illustrates a screen map pin detail view 901, according to an embodiment of the invention. An identifier 903 names the map pin by its geographical location, and a panel 911 provides statistical data on the map pin and its distribution. A related embodiment provides tools for editing, moving, distributing, and deleting map pins, such as a button 921 for removing the map pin from the map. A cancel button 923 closes screen map pin detail view 901 and returns to the previous screen view.

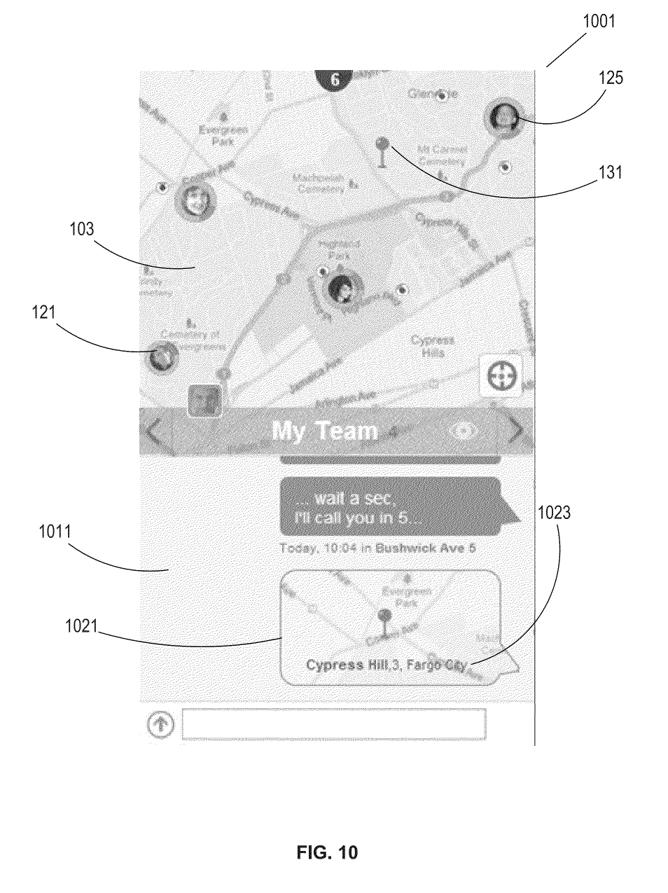

FIG. 10 illustrates a screen 1001 showing a chat pane 1011 with map pin data 1023 sent by the user of the device in a chat balloon 1021 to other team member “Massimiliano” represented by icon 125′, according to an embodiment of the invention. Clicking on chat balloon 1021 alternately places and removes map pin 131 from map 103. As noted previously, map pin 131 is color-coded to match the color of “Me” icon 121.

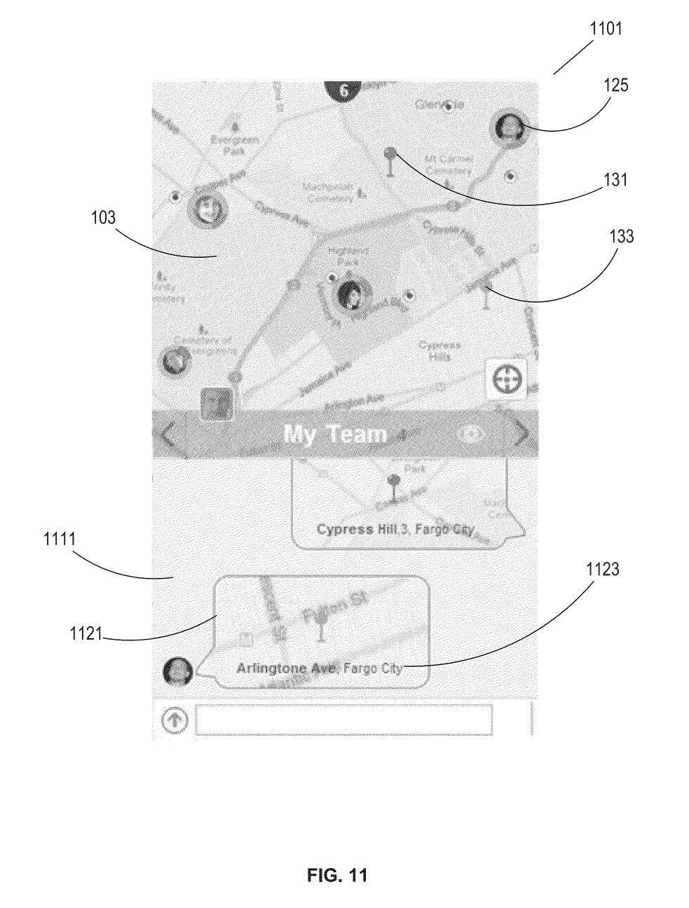

FIG. 11 illustrates a screen 1101 showing a chat pane 1111 with map pin data 1123 received from other team member “Massimiliano” represented by icon 125′, according to an embodiment of the invention. Clicking on chat balloon 1121 alternately places and removes map pin 133 from map 103. As noted previously, map pin 133 is color-coded to match the color of other team member icons, such as icon 125 representing other team member “Massimiliano”.

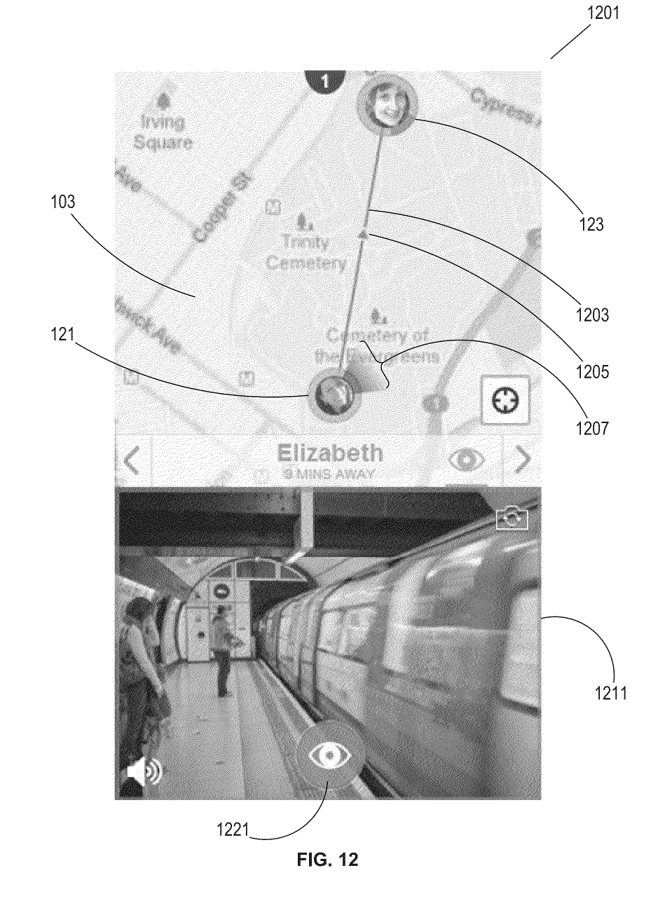

FIG. 12 illustrates a screen 1201 showing a video camera stream 1211 being sent to other team member “Elizabeth” as represented by icon 123 from the user of the device, as represented by “Me” icon 121, according to an embodiment of the invention. A connecting line 1203 shows the flow of video camera stream 1211 in a direction 1205 from the user of the device (“Me” icon 121) to other team member “Elizabeth” (icon 123). As noted previously, connecting line 1203 is color-coded to match the color of “Me” icon 121 to indicate the source of video camera stream 1211. Tapping on a button 1221 allows the sending team member (having the user device) to start and stop the capture of video camera stream 1211.

As illustrated in FIG. 12, an embodiment of the invention provides that each member of the team is a potential camera. The camera illustrated in FIG. 12 is a video streaming camera. For team members with mobile user devices, the potential camera is a mobile camera. In a related embodiment, the icon of a team member indicates the current direction and prospective field of view of the camera. When the camera is in use, the actual field of view is indicated, as shown by a field of view 1207 relative to map 103 in FIG. 12.

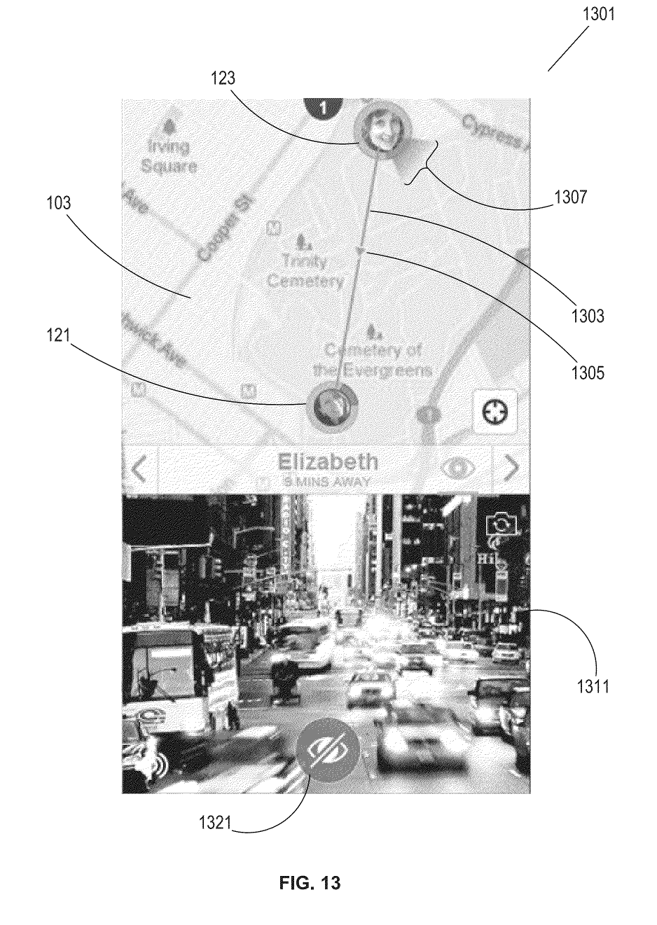

FIG. 13 illustrates a screen 1301 showing a video camera stream 1311 being received from other team member “Elizabeth” as represented by icon 123 to the user of the device, as represented by “Me” icon 121, according to an embodiment of the invention. A connecting line 1303 shows the flow of video camera stream 1311 in a direction 1305 to the user of the device (“Me” icon 121) from other team member “Elizabeth” (icon 123). As noted previously, connecting line 1303 is color-coded to match the color of other team member icon 123 to indicate the source of video camera stream 1311. In a related embodiment, a button 1321 (corresponding to button 1221 of FIG. 12) is disabled—the receiving team member (having the user device, represented by “Me” icon 121) cannot start or stop the capture of video camera stream 1311—in this embodiment, starting and stopping video camera stream capture can be done only by the other team member who originates video camera stream 1311. As before, a field-of-view 1307 of video camera stream 1311 is indicated relative to map 103.

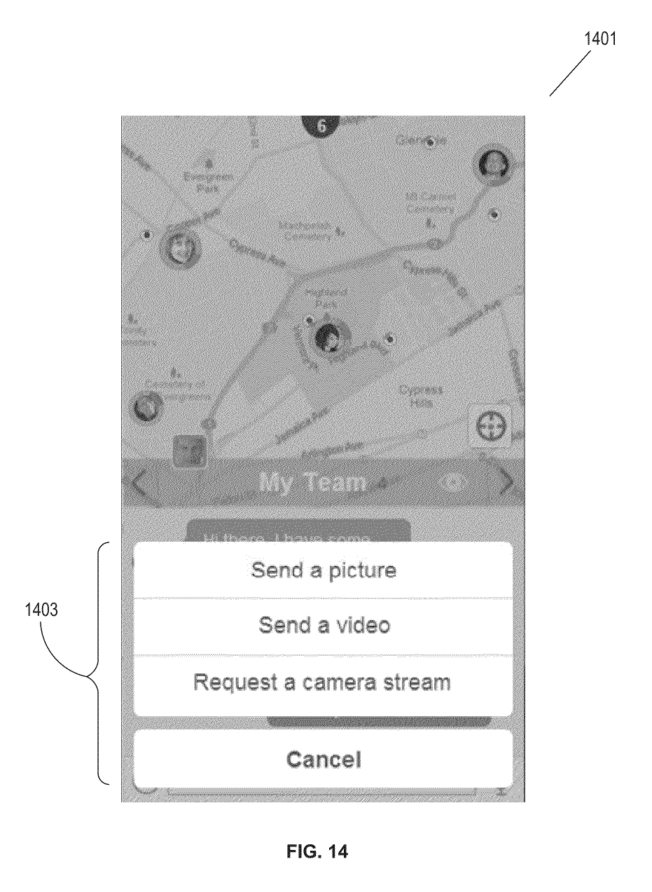

FIG. 14 illustrates a screen 1401 showing a menu 1403 for requesting a video camera stream from another team member, according to an embodiment of the invention. In a related embodiment, additional choices appear on menu 1403, non-limiting examples of which include sending a picture and sending a video, as shown. Menu 1401 is invoked by pressing button 213 (FIG. 2).

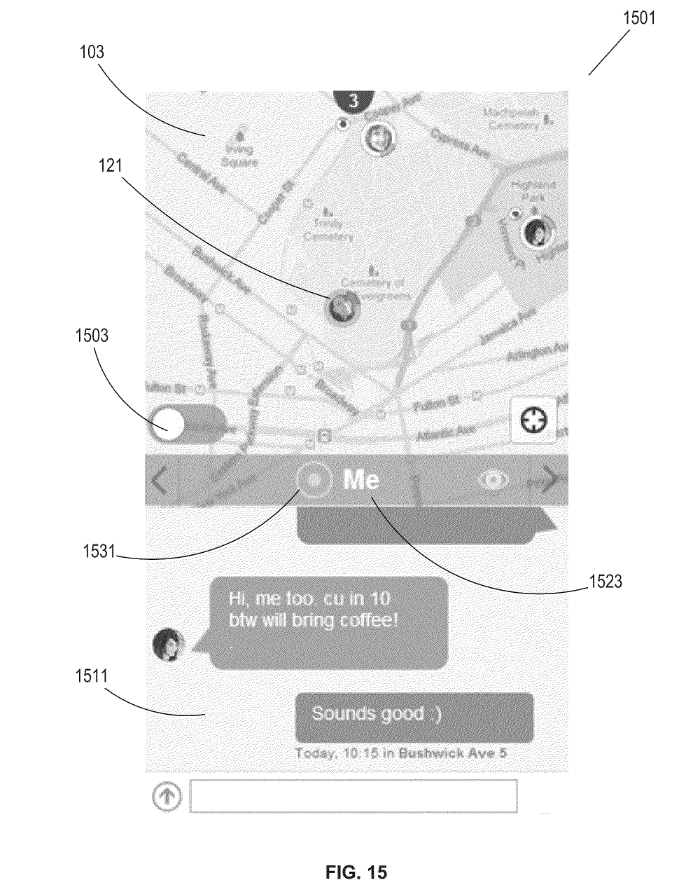

FIG. 15 illustrates a screen “Me” view 1701 for a user device of a team member (represented by “Me” icon 121 showing the team member's location centered on map 103), according to an embodiment of the invention. In “Me” view, the team member sees his or her surrounding environment relative to map 103, along with features and objects of interest. In a related embodiment, there is visible a chat pane 1511 and a banner 1523 identifying the “Me” view. According to certain embodiments, when in “Me” view, a switch 1503 appears, to allow the team member to enable and disable ghost mode. In view 1701, ghost mode is disabled. In a related embodiment, an indicator 1531 shows that view 1501 is map 103 in its regular form as seen in other views, simply having “Me” icon 121 centered but with no additional information displayed.

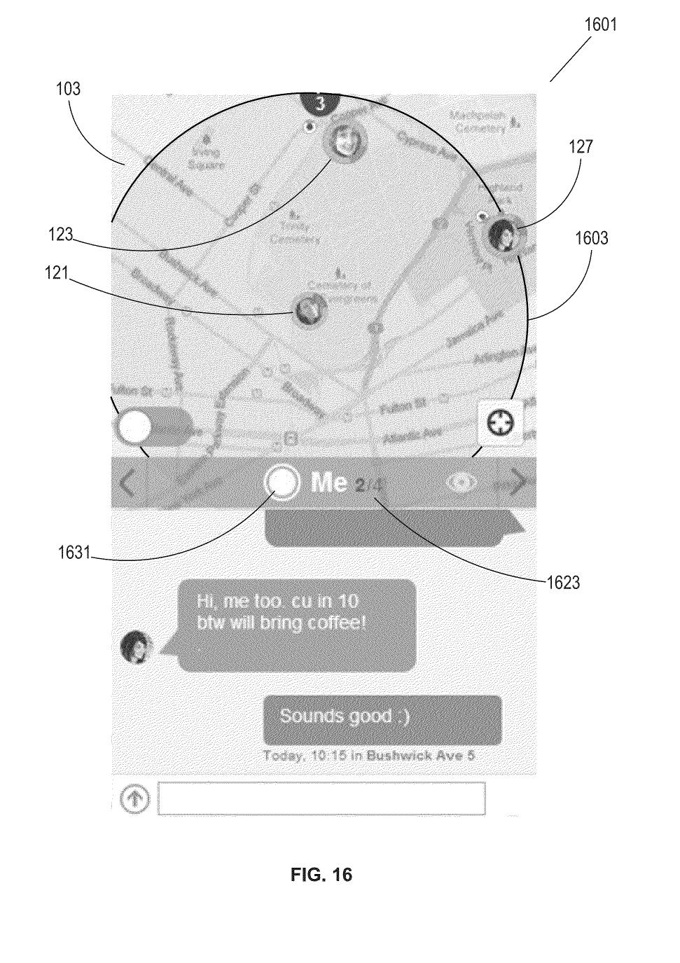

FIG. 16 illustrates a screen “Me” view 1601 for the user device of the team member and with a highlighted central area 1603, according to an embodiment of the invention. In a related embodiment an indicator 1631, which corresponds to indicator 1531 (FIG. 15) shows that view 1601 is map 103 with additional information summarizing the other team members within highlighted central area 1603, including other team member “Elizabeth” (whose location is shown by icon 123 on map 103) and other team member “Paula” (whose location is shown by icon 127 on map 103). In this embodiment the number of other team members within highlighted central area 1603 is listed via an indicator 1623 along with the total number of other team members.

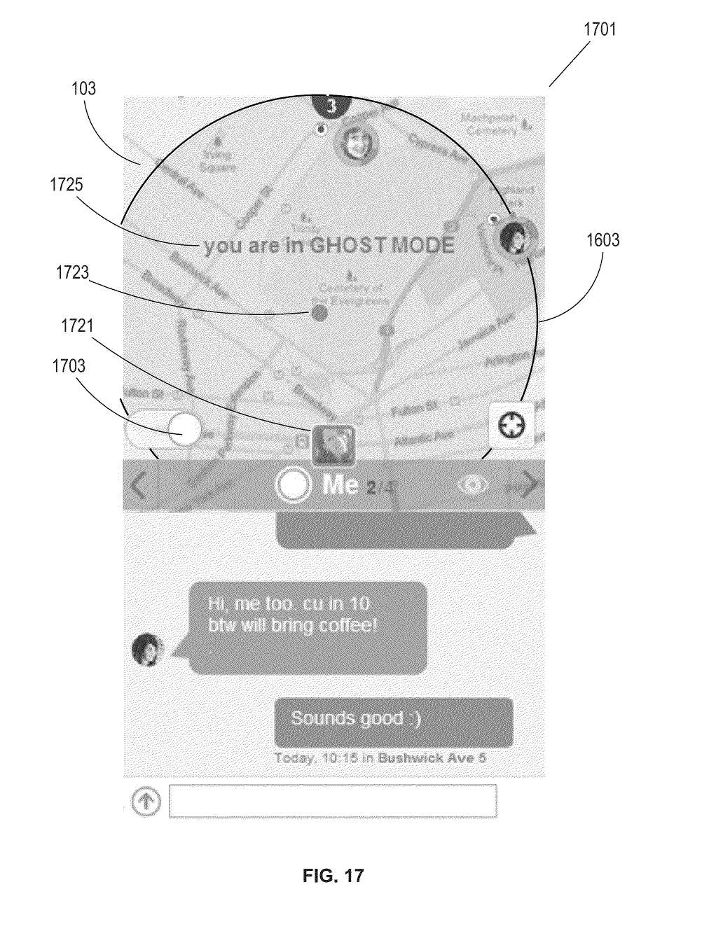

FIG. 17 illustrates a screen “Me” view 1701 for the user device of the team member when in “ghost mode”, according to an embodiment of the invention. A switch 1703 (corresponding to switch 1503 in FIG. 15) is enabled for ghost mode, and a ghost mode “Me” icon 1721 appears at the bottom of map 103, with a location indicator 1723 showing the location of the team member centered on map 103. In these embodiments, the team member in ghost mode can see his or her location on map 103 via location indicator 1723, but other team members do not see a location indicator on their screens. In a related embodiment, the team member also sees a notification 1725 as a reminder that ghost mode is enabled.

What is claimed is:

1. A system for sharing information among a plurality of members of a team, the system comprising a plurality of user devices, wherein each of the user devices has:
a display screen, and
a connection to the Internet or other network;
wherein each member of the team has a user device; and
wherein each of the user devices is configured to:
present a map on the display screen thereof, the map containing:
the location of the user device, and
the location of at least one user device of at least one other team member;
accept an input from a member of the team, the input containing at least one of the group consisting of:
the team as a whole,
the member of the team,
another member of the team,
a predefined geographical hotspot,
a map pin,
a video camera stream,
a data stream from a sensor, and
a chat pane; and
responsively to the input, to enable a communication between at least two members of the team and involving the selected element.

2. The system of claim 1, wherein the user device is further configured to send a video camera stream to another user device, and to graphically indicate the sending on the map.

3. The system of claim 1, wherein the user device is further configured to receive a video camera stream from another user device and to graphically indicate the receiving on the map; and
wherein the user device further configured for at least one of:
store the video camera stream, and
display the video camera stream.

4. The system of claim 1, wherein the user device is further configured to allow a team member to suppress display of the team member's map location on user devices of other team members.

5. The system of claim 1, wherein the user device is further configured to allow a team member to request a video camera stream or a data stream from a sensor from another team member.

6. The system of claim 1, wherein the user device is further configured to display an icon of a team member on the map according to the team member's map location.

7. The system of claim 6, wherein the icon of the team member on the map comprises a visual indicator of a field-of-view of a camera of a user device of the team member.

8. A computer implemented method for sharing information among a plurality of members of a team, each member of the team being provided with at least one user device comprising:
a display screen, and
a connection to the Internet or other network;
the method comprising:
presenting a map on the display screen of at least one display device, the map containing:
the location of the user device, and
the location of at least one user device of at least one other team member;
accepting an input from a member of the team, the input containing at least one of the group consisting of:
the team as a whole,
the member of the team,
another member of the team,
a predefined geographical hotspot,
a map pin,
a video camera stream,
a data stream from a sensor, and
a chat pane; and
enabling a communication between at least two members of the team, responsively to the accepted input and with accordance to the input's content.

9. The method of claim 8, further comprising:
sending a video camera stream from one user device to another user device; and
graphically indicating the sending act on the map.

10. The method of claim 8, further comprising:
receiving a video camera stream from one user device; and
graphically indicating the receiving act on the map.

11. The method of claim 10, further comprising at least one of:
storing the video camera stream; and
displaying the video camera stream.

12. The method of claim 8, further comprising allowing a team member to suppress display of the team member's map location on user devices of other team members.

13. The method of claim 8, further comprising allowing a team member to request a video camera stream and/or a data stream from a sensor from another team member.

14. The method of claim 8, further comprising displaying an icon of a team member on the map according to the team member's map location.

15. The method of claim 8, further comprising presenting a visual indicator of a field-of-view of a camera of a user device of a team member.

16. A non-transitory computer readable medium (CRM) that, when loaded into a memory of a computing device and executed by at least one processor of the computing device, causes the computing device to execute the steps of a method for sharing information among a plurality of members of a team, each member of the team being provided with at least one user device; the method comprising:
presenting a map on the display screen of at least one user device, the map containing:
the location of the user device, and
the location of at least one user device of at least one other team member;
accepting an input from a member of the team, the input containing at least one of the group consisting of:
the team as a whole,
the member of the team,
another member of the team,
a predefined geographical hotspot,
a map pin,
a video camera stream,
a data stream from a sensor, and
a chat pane; and
enabling a communication between at least two members of the team, responsively to the accepted input and with accordance to the input's content.
